(19) United States
(12) Patent Application Publication
(10) Pub. No.: US 2008/0114589 A1
(43) Pub. Date: May 15, 2008

(54) Method For The Flexible Decentralized Provision Of Multilingual Dialogues

(76) Inventors: Detlev Freund, Berlin (DE); Norbert Lobig, Darmstadt (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/793,511

(22) PCT Filed: Nov. 29, 2005
(86) PCT No.: PCT/EP05/56306

§ 371 Date: Jun. 19, 2007

(30) Foreign Application Priority Data
Dec. 21, 2004 (DE) 10 2004 061 524.1

(51) Int. Cl. G06F 17/20

(52) U.S. Cl. 704/8

(57) ABSTRACT

A method for providing language-based services in a telecommunication system is provided. According to the method, the definitions of the respective services are globally defined exclusively in a central service controller and are then converted into regional formats in regional media servers in accordance with predefined transformation rules. In addition, the method utilizes data of the exchange for selecting the desired language.

Numerous features are available to subscribers both in conventional telecommunication networks (“time division multiplexing”—TDM) and also in newer, packet-based telecommunication networks (for example IP networks). Examples of features of this kind and the services associated with them can include the provision of automatic selection menus with voice announcements and speech dialogues.

In the prior art, the control of the services is usually undertaken by a component, which is external from the point of view of the exchange. This takes the form of a so-called application server, to which all the information required for defining the individual services is available. The whole of the complex intelligence for the services provided therefore lies on these application servers, which, at the same time, monitor and control all parameters of the required service and in doing so evaluate the responses from the subscribers.

The definitions of the voice-operated services stored on the application servers are usually highly complex with regard to the operational sequence and, in addition, are usually extremely comprehensive. The complexity of the services naturally increases even further in the case of multinational scenarios due to the numerous different languages, which have to be offered.

Because of the large number of files required for the services, in the prior art, these files are not stored on the application servers themselves but on so-called media servers or in a database accessible to the respective media servers. When providing the service, i.e. when playing the appropriate audio files, the application server then requests the voice announcements required for the particular application from one of these media servers. This request can be made directly or also indirectly via an exchange. The media servers themselves can be installed both centrally in the network and also local to the subscriber.

The voice announcements and dialogues are usually controlled by the user of a service by means of the conventional DTMF interface (“dual tone multi-frequency” interface). Modern types of speech-based services of this kind however use automatic speech recognition for easier navigation through the speech dialogues. This enables both DTMF-suitable dialogues, which follow a selection menu, as well as natural speech dialogues to be supported. In the case of such a natural speech dialogue, open questions are used and the voice inputs are freely formulated. Here, the appropriate subsequent questions are determined by the combination of recognized keywords. The user is thus given the impression of communicating with a human contact.

However, with a control of this kind using natural speech inputs, an additional transmission of further parameters is necessary (for example of said keywords). As the DTMF interface is not intended for such a transmission, suitable control protocols such as MRCP V1 (“media resource control protocol version 1”) or MRCP V2 (“media resource control protocol version 2”) have been defined for the interface between the speech processing component and the component of a media server, which controls the logic of the dialogue, for the requirements of speech recognition and speech synthesis. With the help of these protocols, it is also possible, for example, to carry out the data transmission between the media servers and the application servers, which is necessarily more elaborate for speech recognition.

In the case of multinational scenarios, in addition, the required language is usually determined at the beginning of the service by means of a selection dialogue. However, any data relating to the respective subscribers, which is held in the exchange of the telecommunication network (such as the preferred language or the region in which the subscriber is located, for example) is not taken into account in this selection.

A disadvantage of the prior art is that a loading process must be carried out for all media servers when the services are updated. That is to say, an updated version of the appropriate speech dialogues must be installed on all media servers or, if necessary, in the appropriate databases associated with the media servers. In order to carry out such a loading process, the media servers or the external databases associated with the media servers require appropriate loading logic and an additional protocol interface, which qualifies the loading process (e.g. FTP—“File Transfer Protocol”) and, in particular, appropriate operating access by personnel. However, the personnel are not usually familiar with the definition and updating of services and speech dialogues.

A further problem with the prior art is the complexity of the services described above. Even the definition of a simple service is therefore very confusing when this has to be offered in several regions, sometimes in different ways. Furthermore, several different languages may have to be offered for each region, for example. Previously, each of these special cases has therefore had to be defined as an individual, specific service in the application server. For more elaborate services, which include longer dialogue sequences, for example, or are in multiple steps, this problem naturally further increases the complexity.

The invention is based on the object of specifying a method, which is capable of providing speech-based services in a telecommunications system more efficiently and more easily.

An advantage of the invention is the fact that each service only has to be defined once globally in a reference language. In the case of a multinational network, a regional version of the global service, which is adapted to suit the special characteristics of the region, is produced automatically for each region. By means of the method according to the invention, in principle, a new service is accordingly already available in all regions once it has been globally defined.

If suitable protocols are used, then a further advantage of the invention arises from the fact that, when a service is updated, relevant data can also be transmitted via the signaling protocol interfaces.

A further advantage of the invention is the use of the information in the exchange when selecting the language to be used. This information contains particulars of the region in which the subscriber is located, and can therefore be advantageously incorporated when selecting the language. In mobile radio scenarios, this data can be taken from the so-called Home Location Register (HLR) for example.

The invention is now explained in more detail below with the help of the attached drawings, in which

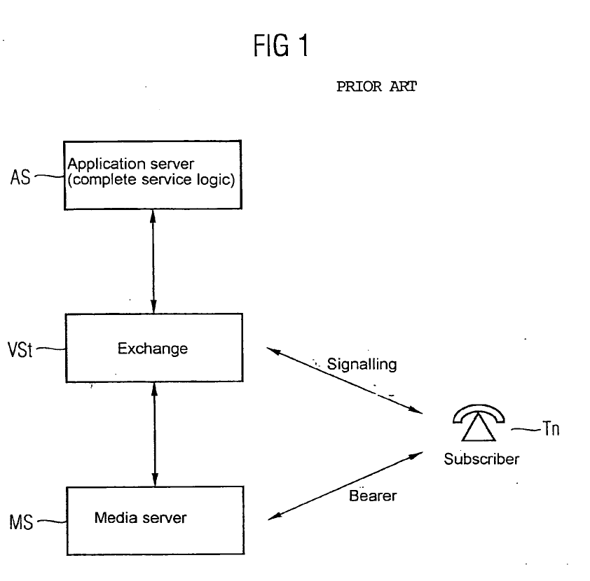

FIG. 1 shows the provision of a service in a telecommunication network according to the prior art, and

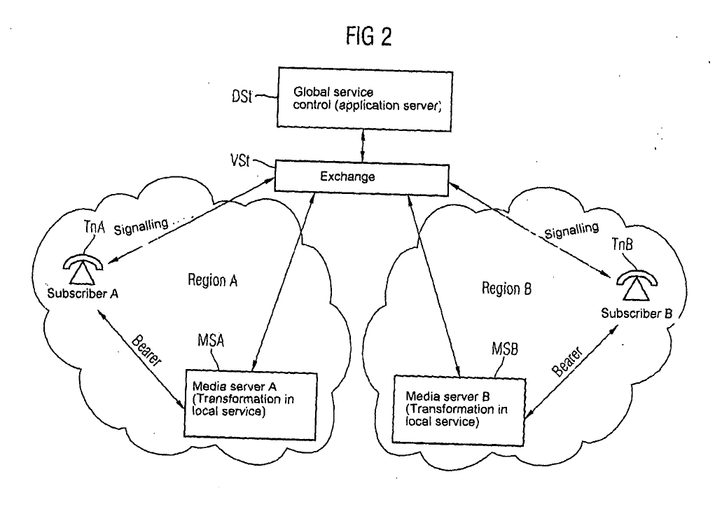

FIG. 2 shows an embodiment of the method according to the present invention.

FIG. 1 shows a structure for providing a voice-operated service in a conventional telecommunication network according to the prior art. Here, a subscriber Tn requests a voice-operated service via a classical TDM or IP network. This request can be made explicitly by the subscriber (for example by dialing a service number) or implicitly by network functions (e.g. an authorization inquiry for subscriber actions, a speech dialogue when a subscriber is engaged, a changed telephone number, etc.).

The signaling data is then transmitted to an exchange VSt, which forwards the request to an application server AS. This contains the definitions of voice-operated services offered in the telecommunication network. In the case of multinational networks, particularly-in the case where the exchange provides its services for several national networks, i.e. simultaneously includes several logical exchanges with different system characteristics, a dedicated, specific service definition for each region is accordingly also stored in the application servers.

In the next step, exchange VSt transmits the service instructions received from application server AS to a media server MS, which transmits the required voice messages (or audio files) to subscriber Tn or conducts dialogues with subscriber Tn. The response from subscriber Tn is transmitted back to application server AS where it is processed in accordance with the service definition. If control by subscriber Tn is carried out by means of the DTMF interface, then these signals are transmitted directly to the application server AS. However, if the control is to work with speech recognition, the language must additionally be converted to signals, which can be transmitted via the existing interface. Because of the more favorable conditions for a high recognition probability, this conversion is preferably already carried out decentrally in media server MS.

If necessary, further instructions are then sent to media server MS or responses are received from subscriber Tn and evaluated until the end of the dialogue. When the services are updated or a new service is added, both the service definitions in the application server AS and the data describing the appropriate announcements and dialogues are replaced in all media servers MS and in the associated databases (not shown) by means of a loading process.

An exemplary embodiment of the method according to the present invention is shown in FIG. 2. In this example, two subscribers TnA and TnB from two different regions A and B with regard to the national language request a voice-operated service.

The respective signaling data is forwarded from exchange VSt to a global service controller DSt (corresponding to the application server from FIG. 1). The global service controller DSt now determines the desired language for the required service. This is usually carried out with the help of an initial dialogue, which provides the subscribers TnA and TnB with a choice of all languages offered. The subscribers can now select the desired language, for example, by means of DTMF control or voice control. At the same time, a further aspect of the invention is the possibility of using the information relating to the subscribers TnA and TnB held by the exchange to help in determining the desired language. In this way, the language selection may be dispensed with or reduced to a request for confirmation. As exchange VSt has information as to where the subscribers TnA and TnB are located (possibly by means of country code or local area code of subscribers TnA and TnB or the entries in the HLR), this information can already reduce the choice of language. A language, which is frequently spoken in the particular subscriber's region, is then placed at the top of the selection list, for example. Another possibility is to set the appropriate language directly as the default language and, if necessary, simply incorporate an additional menu item for changing the language in the dialogue.

When the language desired by the subscribers TnA and TnB has been selected and confirmed, the global service controller DSt forwards the appropriate service instructions to the appropriate regional media servers MSA and MSB respectively in the global language. The media servers MSA and MSB contain transformation rules for converting global instructions to their respective regional formats. After translating the instructions into the regional format, the media servers MSA and MSB determine the versions of the speech dialogues, which are matched to their specific region, and transmit these to the subscribers TnA and TnB. These voice messages are stored as audio files or text files either on the media servers MSA and MSB themselves or in associated databases (not shown), which the media servers MSA and MSB can access as required.

The subsequent dialogue continues between subscribers TnA and TnB, the global service controller DSt and the appropriate media servers MSA and MSB respectively in accordance with the method described above. Service controller DSt outputs service instructions in the global language to the appropriate media servers MSA and MSB respectively, which convert the instructions into the regional format in accordance with the transformation rules, and send the requested voice messages to subscribers TnA and TnB respectively.

If the responses from subscribers TnA and TnB are transmitted by voice, then these are evaluated locally, preferably directly in the respective media servers MSA and MSB. This results in a neutral parameter form or region-specific voice input information (e.g. a sequence of keywords with associated recognition probabilities). This data is then converted into the global format in accordance with the transformation rules and sent to the global service controller DSt.

When a service is updated or newly added, the regional version of the service is produced directly from the global definition and the regional transformation rules. Modified or even new services must therefore only be globally defined once. The regional formats are automatically produced in the regional media servers MSA and MSB respectively by means of the defined transformations.

The voice messages are also produced decentrally. For this purpose, the media servers MSA and MSB can avail themselves of a set of pre-specified audio and text definitions, which are put together in accordance with the transformed global rules. A loading process is therefore only necessary when completely new audio files have to be added.

According to the method, this loading process, which requires a separate loading interface, can also be bypassed if only the delta definition of the services is transmitted between application server and media server as part of the service signaling while fully utilizing the signaling interfaces and the characteristics of the control protocol for example. This has additional advantages with regard to aspects of security (firewalls) and maintenance. In this case, therefore, it is not necessary for the network operator's operating and maintenance personnel to carry out a separate operation in order to adapt the services to suit the requirements of customers.

Compared with voice recordings using professional speakers, text files allow announcements to be updated even more quickly. They can be included in the method according to the invention if they are converted to the regionally desired languages by means of automatic translation, and if it is possible to connect a suitable regional language TTS (“text-to-speech”) functional device downstream.

1.-10. (canceled)

11. A method for providing speech-based services in a multinational telecommunication system, comprising:
globally defining each service in a reference language; and
automatically producing a regional definition of the service for each region from the global definition.

12. The method according to claim 11, wherein the service includes announcements, sequences of announcements, sound inputs or voice inputs.

13. The method according to claim 11, wherein the multinational telecommunication system is an exchange that serves a plurality of subscriber connections and connecting cables in a plurality of national telecommunication networks with different national languages.

14. The method according to claim 11, wherein the reference language is identical to one of the national languages to be served.

15. The method according to claim 11, wherein the automatic production occurs decentrally in a regional media server.

16. The method according to claim 11, wherein a speech recognition occurs regionally and at least one device for recognizing speech exists per region.

17. The method according to claim 11, wherein properties that describe and define the service, include keywords, sequences of keywords, grammar, recognition system settings, and recognition system outputs as well as speech files and text.

18. The method according to claim 11, wherein properties that describe and define the service are transmitted as part of the signaling.

19. The method according to claim 11, wherein the reference language includes text to be output via a speech synthesis and are automatically converted to regional languages via a suitable translation function and a regionally relevant speech synthesis function.

20. The method according to claim 11, wherein information of a database of the exchange or information made available to this as part of the processing of the connection is used for determining the desired language.

21. The method according to claim 11, wherein the service includes at least one announcement, sequence of announcements, sound input or voice input.

22. The method according to claim 21, wherein the multinational telecommunication system is an exchange that serves a plurality of subscriber connections and connecting cables in a plurality of national telecommunication networks with different national languages.

23. The method according to claim 22, wherein the reference language is identical to one of the national languages to be served.

24. The method according to claim 23, wherein the automatic production occurs decentrally in a regional media server.

25. The method according to claim 24, wherein a speech recognition occurs regionally and at least one device for recognizing speech exists per region.

26. The method according to claim 24, wherein a property that describes and defines the service, includes at least: one keyword, sequence of keywords, grammar, recognition system setting, recognition system output, speech file, or text.

27. The method according to claim 26, wherein the property is transmitted as part of the signaling.

28. The method according to claim 24, wherein the reference language includes text to be output via a speech synthesis and are automatically converted to regional languages via a suitable translation function and a regionally relevant speech synthesis function.

29. The method according to claim 24, wherein information of a database is used for determining the desired language.

30. The method according to claim 24, wherein information the exchange is used for determining the desired language.
